(19) United States
(12) Patent Application Publication
(10) Pub. No.: US 2009/0051503 A1
(43) Pub. Date: Feb. 26, 2009

(54) WIRELESS TIMER SYSTEM

(76) Inventors: Jeffrey Bowman, Atlantic Beach, FL (US); Ambreese Sharif Hill, Jacksonville, FL (US); Robert J. Pape, Ponte Vedra Beach, FL (US); Robert E. Beasley, Germantown, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 11/875,230

(22) Filed: Oct. 19, 2007

Related U.S. Application Data
(60) Provisional application No. 60/853,860, filed on Oct. 23, 2006.

(51) Int. Cl. G08B 1/00

(52) U.S. Cl. 340/309.4

(57) ABSTRACT

A wireless timer system (10) is shown including a master unit (12) and multiple remote modules (13). The master unit communicates with the slave units through a RF signal. The master unit includes a control circuit for controlling the activation of the remote modules during at least one designated activation time period having a commencement time and a termination time. The designated activation time period including a plurality of on/off cycles. The control circuit changes the selection of which remote module to activate first upon each occurrence of reaching the designated activation time period. The control circuit may also include a variable time range associated with the activation time period. The control circuit may change the commencement time each day to a time within the variable time range from the commencement time.

### REFERENCE TO RELATED APPLICATION

Applicant claims benefit of U.S. Provisional Patent Application Ser. No. 60/853,860 filed Oct. 23, 2006.

### TECHNICAL FIELD

This invention relates to timers used to actuate the operation of lights or other electrical devices, and more specifically to wireless timer systems having several remote devices.

### BACKGROUND OF THE INVENTION

For many years timers have been utilized to turn lights on and off throughout a house in the absence of an individual. These timers may be used in this manner to provide the appearance that someone is presently within the house. These timers may also be used to turn on a light prior to the arrival of an individual at a regular arrival time.

The timer itself is typically operated on the household current, as shown in U.S. Pat. No. 3,925,629. Should the household current be interrupted for any significant time period, the timer does not actuate the lamps at the desired actuation times due to the current time becoming inaccurate.

Another problem with these timers is that they typically operate the lamp once per day. The once a day illumination of a light does not provide the appearance of someone at home, wherein that person typically moves from room to room turning lights on and off along the way.

Lastly, these times typically turn on and off and exactly the same time every day. Again, this does not provide the appearance of someone at home as people typically do not turn lights on and off at exactly the same time on a daily basis.

Accordingly, it is seen that a need remains for a timer system that will operate accurately but which also provides a better representation of a person residing within the home. It is to the provision of such therefore that the present invention is primarily directed.

### SUMMARY OF THE INVENTION

A wireless timing system comprises a plurality of remote modules having a receiver, a male plug configured to be received within a conventional female electrical socket, and a female socket configured to receive a conventional male plug. The system also includes a master unit including a control circuit and a transmitter in communication with the receivers of the plurality of remote modules. The control circuit controls the activation of the plurality of remote modules during at least one designated activation time period having a commencement time and a termination time. The at least one designated activation time period includes a plurality of on/off cycles. The control circuit changes the selection of which remote module of the plurality of remote modules to activate first upon each occurrence of reaching the designated activation time period. With this construction, changing the selection of which remote module activates first each day during the designated activation time period reduces the appearance of a mechanically controlled timing system.

In another form of the invention a wireless timing system comprises at least one remote module having a receiver, a male plug configured to be received within a conventional female electrical socket, and a female socket configured to receive a conventional male plug. The system also includes a master unit including a control circuit and transmitter in communication with the receiver of the remote module. The control circuit controls the activation of the at least one remote module during at least one designated activation time period having a commencement time and a termination time. The control circuit also including a variable time range associated with the activation time period. The control circuit changes the commencement time each day to a time within the variable time range from the commencement time. With this construction, the changing of the commencement time each day to a time within the variable time range from the commencement time of the designated activation time reduces the appearance of a mechanically controlled timing system.

### BRIEF DESCRIPTION OF THE DRAWING

FIG. 1 is a front view of a wireless timer system embodying principles of the invention in a preferred form, showing the master unit.

FIG. 2 is the left side view of the timer master unit of FIG. 1.

FIG. 3 is a cross-sectional view of the timer master unit of FIG. 1.

FIG. 4 is a front view of a remote unit.

FIG. 5 is a left side view of the remote unit of FIG. 4.

FIG. 6 is a right side view of the remote unit of FIG. 4.

FIG. 7 is a cross-sectional view of the remote unit of FIG. 4.

FIG. 8 is a bottom view of the remote unit of FIG. 4.

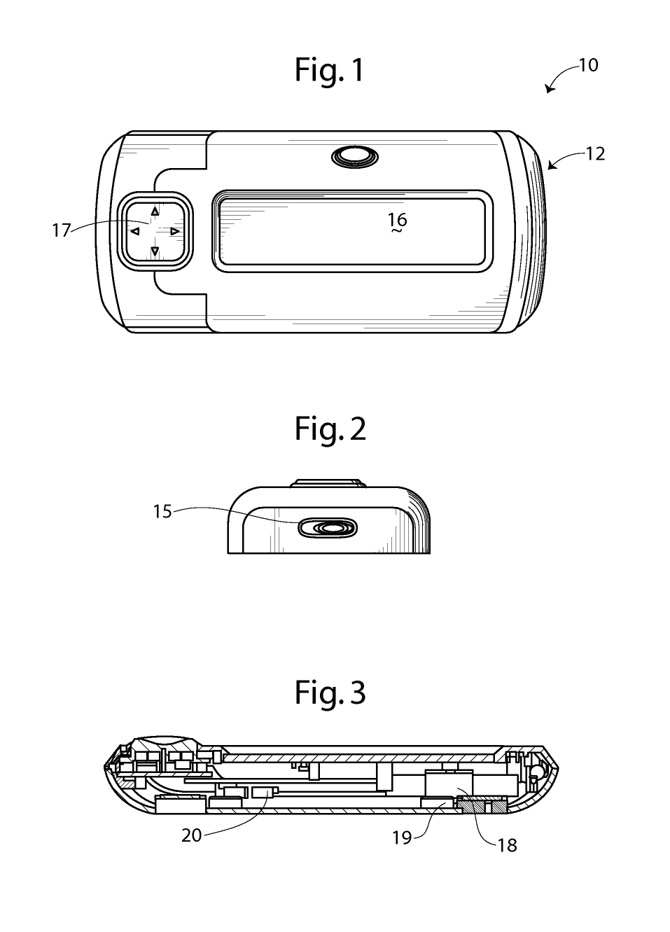

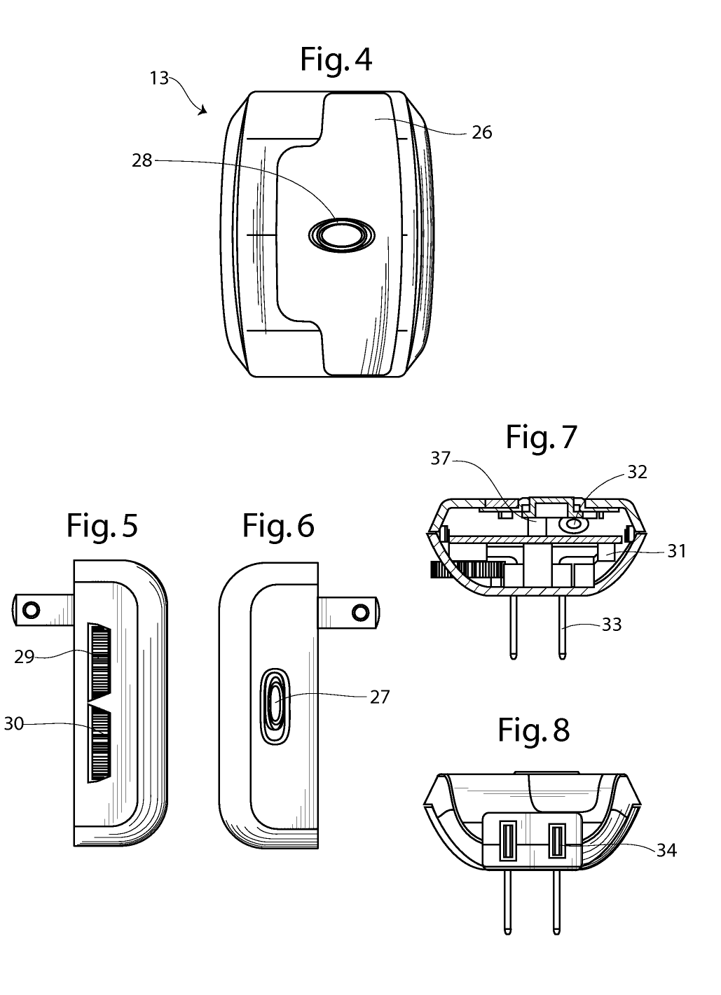

### DETAILED DESCRIPTION

With reference next to the drawings, there is shown a wireless timer system 10 in a preferred form of the invention. The timer system 10 includes a master unit 12 and multiple slave units or remote modules 13. The master unit 12 communicates with the slave units 13 through a RF signal, as described in more detail hereinafter.

The master unit 12 has a program switch 15, LCD screen 16 and a four directional actuation button 17. Internally, the master unit includes a receiver unit 18, a transmitter unit 19, a circuit, a battery back-up, a satellite atomic clock transceiver, a controller or control circuit 20, and memory. The master unit 12 receives a time signal through a receiving unit 18. The transmitter unit 19 wirelessly transmits a signal to the remote modules 13. These elements of the master unit 12 serve to receive, process and transit the information used to operate the remote modules.

Each remote module 13 has a photocell 26, a manual on/off button 27 which is lit by an LED light 28, a rotatable program selector switch 29, a rotatable photocell sensitivity switch 30, a receiver 31, a battery 32, a male plug 33, and a female socket 34. Each of the remote modules 13 includes an antenna 36 coupled to the receiver 31 which wirelessly receives a signal from the master unit transmission unit 19. Each remote module 13 also includes a processor 37 to process the signal and the instruction provided through the selected positioning of the program selector switch 29.

To initially set the timer system 10, an operator actuates the master unit actuation button 17 in accordance with directions appearing on the LED screen 16 in order to set the appropriate parameters. The controller first requests an input for the time zone, example eastern, central, mountain and pacific. Once the time zone is selected and entered the controller requests whether the operator wishes to set the on/off times of the remote modules 13. If the operator enters “yes”, the screen instructs the operator to connect all remote modules 13 to respective conventional electrical outlets through their male plugs 33 and to insert the male plug of a lamp into the respective remote module female sockets 34. The controller then instructs the operator to select a RF channel, for example of 3 RF channels available. The purpose of the choice of channels is to reduce the possibility of RF interference by other systems within the area. Should one encounter such RF interference the operator may select another channel. The controller however may inquire whether the operator wishes to test the range of the remote module. A “yes” selection initiates a test which is indicated by a flashing of light 28 while the controller sends an RF signal to the remote modules to turn off. The operator can then walk room to room to confirm this has occurred. A lamp that remains illuminated indicates that the remote module did not receive the RF signal and therefore should be moved to a different location. The operator may then re-initiate the test to determine if all lamps have been turned off.

The controller then inquires as to the number of remote modules utilized. The number of remote modules is entered into memory of the processor so that it may be used when the system is operating in a smartrandom mode of operation, the smartrandom mode representing a mode of operation wherein the system staggers the rotation of the automatic on/off cycles so that there are always 1 or 2 lamps lit in the home during a select designated activation time period (for example between 5:30 and 11:30 p.m., wherein 5:30 represents the time period commencement time and 11:30 represents the time period termination time). It should be understood that this is the number of remote module program command letters the user is setting and is not the total number of remote modules. For example, the system may contain three remote modules having a factory setting program command of A, B and C, so that the number entered is three. However, the operator may reset the program selector switch 29 so that two remote modules are set to A and one is set to B. Here, the number entered would be 2 since there are only 2 remote module program commands. Once the number of remote modules is entered the controller then requests whether the operator wishes to set the timer system for “home” mode, “home” mode being the mode of operation for the system when a person is intended to be present within the house. Should the operator enter “yes” to this query the controller will request the entry of the appropriate timing programs. The timing program choices are smartrandom, seven days the same, alternate days, and week/weekend. The seven days the same program actuates the timing sequence the same for each day of the week. The alternating days program changes the timing sequence so that two timing sequences are utilized and each operated every other day. The week/weekend program changes has one timing sequence for the days Monday through Friday and a second timing sequence for Saturday and Sunday.

If a selection is made other than smartrandom the controller request the entry of either “variable” or “exact” mode. The exact mode operates the system at exactly the time intervals entered by the operator, typically the system allows entry of fifteen minute intervals. The variable mode allows the controller to take the desired time and varies it daily within a select time variable, for example plus or minus ten minutes, so that the actual time a lamp is illuminated changes daily to some degree, thereby avoiding the appearance of a timer actuating the lamp every day at the exact same time and enhancing the appearance that someone is within the home.

Next the controller requires the entry of the desired times for each remote module to be turned on and off. Each module may be turned on and off multiple times within the same day. The operator enters the time information accordingly. As an option, the controller may inquire whether all remote modules should have the same on and off times, this option streamlines the programming process as all remote module times may be programmed at once rather than one at a time. Should this option not be utilized, the operator must enter the on and off times associated with each remote module.

Should the previous inquiry regarding the entry of the “home” mode result in an operator's entry of “no”, the controller inquires whether the operator wishes to set the “away” mode settings. If the operator responses with the entry of a “yes” command, the controller inquires the same data previously recited in reference to entry of the “home” mode of operation. These inquires are generally the request to enter the type of timing program, the exact time or variable time entry, and the on and off time entries.

Should the operator respond to the “away” mode setting with a “no” entry, the controller inquires whether the operator wishes an automatic time set entry. A “yes” entry results in the controller informing the operator that the programming process in complete and the controller will automatically set the month, day, year, hour, minute, am/pm and day according to the input received from the radio controlled clock. A “no” entry causes the controller to query the month, day, year, hour, minute, am/pm and day, the entry of which is controlled by the operator.

Once the programming is completed the program selector switch 15 is moved to a desired position by the operator. The controller will constantly utilize the radio controlled clock to maintain the correct present time within the system.

In use, the system radio controlled clock monitors the current time signal and corrects it within the system if a discrepancy occurs. In this manner, should the municipal power be interrupted, once power is restored the radio controlled clock resets the system to the accurate time. As such, the programmed time to illuminate the lamps is maintained rather than being delayed for the time period during which power was interrupted, i.e., should a 2 hour power interruption occur the system programs still turn the lights on at the proper time rather than being delayed by 2 hours.

With the system's smartrandom mode of operation the automatic on/off cycles occur so that there are always 1 or 2 lamps lit in the home during a select time period. For example, between the hours of 5:30 and 11:30 a six hour period occurs. The six hour period is divided by the number of remote modules codes the operator activates (for example A, B and C=3). The number of codes is then multiplied by two (as each code is utilized two times per night, the number of times however may be changed as an option). This result in the number of different lamp on/off times that can occur. For instance, three remote modules will provide six on/off cycles while five remote modules provide ten on/off cycles. In the case of three remote modules, the number of on/off cycles equals six and the controller divides the number of on/off cycles by the number of hours in the period of operation (six (cycles) divided by six (hours)) which equates to one hour per cycle, which is referred to herein as the BASE TIME.

The smartrandom mode utilizes the VARIABLE setting automatically, which means that the first on time is 5:30 +/−10 minutes. The choice of which remote module and operation time changes randomly every day, i.e., the controller may randomly select which module to initially activate so that the same light is not turned on consecutive days, thus enhancing the appearance that someone is home and that an automatic system is not operating the lights. Here, the first chosen remote module is activated for one hour with the second chosen remote module commencing activation fifteen minutes before the off time of the first chosen remote module. Each remote module will be activated twice per night with each turning on fifteen minutes before the preceding remote module turns off. Each time is shifted by the same variable amount relating to the VARIABLE setting, i.e., each on/off time is shifted by the same +/− time increment.

It should be understood that an advantage of the present invention is its ability to actuate a light multiple times through the course of a night. This ability provides a benefit over systems of the prior art which limited the operation of a light to once a night.

It should be understood that a remote key unit may be included in the timer system. The remote key includes a transmitter that signals the master unit. This signal may be result in the master unit overriding the current program or modify such. For instance, it may be programmed to turn on select lights regardless of the program.

It should be understood that the control circuit may change the selection of which remote module to activate first upon reaching the designated activation time period. As such, changing the selection of which remote module is activated first each day during the designated activation time period reduces the appearance of a mechanically controlled timing system. This changing of the selection can be accomplished in a random manner through the controller or through a selective programming or inputting of the desired modules by an individual.

It thus is seen that a timer is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A wireless timing system comprising:
a plurality of remote modules, each remote module having a receiver, a male plug configured to be received within a conventional female electrical socket, and a female socket configured to receive a conventional male plug;
a master unit including a control circuit and a transmitter in communication with said receivers of said plurality of remote modules, said control circuit controlling the activation of said plurality of remote modules during at least one designated activation time period having a commencement time and a termination time, said at least one designated activation time period including a plurality of on/off cycles, said control circuit includes a random mode which changes the selection of which remote module of said plurality of remote modules to activate first upon each occurrence of reaching said designated activation time period,
whereby changing the selection of which remote module activates first each day during the designated activation time period reduces the appearance of a mechanically controlled timing system.

2. The wireless timing system of claim 1 wherein said control circuit random mode varies said commencement time of said designated activation time period within a range of commencement times.

3. The wireless timing system of claim 1 wherein said plurality of remote modules includes at least three remote modules, and wherein said control circuit random mode randomly selects which remote module to select for each said on/off cycle of said designated activation time period.

4. The wireless timing system of claim 1 wherein each said on/off cycle overlaps in time another on/off cycle.

5. The wireless timing system of claim 1 wherein said control circuit controls a plurality of designated activation time period each having a commencement time and a termination time.

6. The wireless timing system of claim 1 wherein said control circuit also includes a manual override mode which allows said control circuit to control which said remote module to activate according to a select entry entered into the control circuit rather than being selected through said random mode.

7. A wireless timing system comprising:
at least one remote module having a receiver, a male plug configured to be received within a conventional female electrical socket, and a female socket configured to receive a conventional male plug;
a master unit including a control circuit and transmitter in communication with said receiver of said remote module, said control circuit controlling the activation of said at least one remote module during at least one designated activation time period having a commencement time and a termination time, said control circuit also including a variable time range associated with said activation time period, said control circuit changing the commencement time each day to a time within said variable time range from said commencement time,
whereby the changing commencement time each day to a time within the variable time range from the commencement time of the designated activation time reduces the appearance of a mechanically controlled timing system.

8. The wireless timing system of claim 7 wherein said at least one designated activation time period including a plurality of on/off cycles, and said control circuit randomly selects which remote module of said plurality of remote modules to activate first upon reaching said designated activation time period

9. The wireless timing system of claim 7 wherein said wireless timing system includes at least three remote modules, and wherein said control circuit randomly selects which remote module to select for each said on/off cycle of said designated activation time period.

10. The wireless timing system of claim 8 wherein each said on/off cycle overlaps in time another on/off cycle.

11. The wireless timing system of claim 7 wherein said control circuit controls a plurality of designated activation time period each having a commencement time and a termination time.

12. The wireless timing of claim 7 wherein said control circuit also includes a manual override mode which allows said control circuit to control which said remote module to activate according to a select entry entered into the control circuit rather than being selected through said random mode.

13. A wireless timing system comprising:
a plurality of remote modules, each remote module having a receiver, a male plug configured to be received within a conventional female electrical socket, and a female socket configured to receive a conventional male plug, each receiver is associated with a select frequency of a plurality of select frequencies, and
a master unit including a control circuit and a transmitter in communication with said receivers of said plurality of remote modules through said plurality of select frequencies, said control circuit controlling the activation of said plurality of remote modules during at least one designated activation time period having a commencement time and a termination time, said at least one designated activation time period including a plurality of on/off cycles, said control circuit determining the number of on/off cycles during the course of said designated activation time period through a function of the number of select frequencies utilized by said plurality of select frequencies.

14. The wireless timing system of claim 13 wherein said control circuit includes a random mode which changes the selection of which remote module of said plurality of remote modules to activate first upon each occurrence of reaching said designated activation time period,
whereby changing the selection of which remote module activates first each day during the designated activation time period reduces the appearance of a mechanically controlled timing system.

15. The wireless timing system of claim 13 wherein said control circuit also including a variable time range associated with said activation time period, said control circuit changing the commencement time each day to a time within said variable time range from said commencement time,
whereby the changing commencement time each day to a time within the variable time range from the commencement time of the designated activation time reduces the appearance of a mechanically controlled timing system.

16. The wireless timing system of claim 13 wherein each said on/off cycle overlaps in time another on/off cycle.

17. The wireless timing system of claim 14 wherein said control circuit also including a variable time range associated with said activation time period, said control circuit changing the commencement time each day to a time within said variable time range from said commencement time,
whereby the changing commencement time each day to a time within the variable time range from the commencement time of the designated activation time reduces the appearance of a mechanically controlled timing system.

18. The wireless timing system of claim 15 wherein said control circuit includes a random mode which changes the selection of which remote module of said plurality of remote modules to activate first upon each occurrence of reaching said designated activation time period,
whereby changing the selection of which remote module activates first each day during the designated activation time period reduces the appearance of a mechanically controlled timing system.
